(19) United States
(12) Patent Application Publication
(10) Pub. No.: US 2022/0225361 A1
(43) Pub. Date: Jul. 14, 2022

(54) METHOD AND APPARATUS FOR TRANSMITTING/RECEIVING WIRELESS SIGNAL IN WIRELESS COMMUNICATION SYSTEM

(71) Applicant: LG ELECTRONICS INC., Seoul (KR)

(72) Inventors: Youngdae Lee, Seoul (KR); Jiwon Kang, Seoul (KR); Jaehoon Chung, Seoul (KR)

(21) Appl. No.: 17/574,375

(22) Filed: Jan. 12, 2022

(30) Foreign Application Priority Data
Jan. 13, 2021 (KR) 10-2021-0004503

(51) Int. Cl. H04W 72/12; H04L 1/18

(52) U.S. Cl. CPC H04W 72/1268; H04W 72/1289; H04L 1/1812; H04W 72/1231; H04W 72/1242

(57) ABSTRACT

The present disclosure discloses a method of receiving a signal by a user equipment (UE) in a wireless communication system, including configuring a first transmission and reception point (TRP) using resources of a first cell, configuring a second TRP using resources of a second cell, receiving first downlink control information (DCI) scheduling a first physical uplink shared channel (PUSCH), receiving second DCI scheduling a second PUSCH, transmitting the first PUSCH to the first TRP, and transmitting the second PUSCH to the second TRP. The first DCI and the second DCI include information about a hybrid automatic repeat request (HARQ) process identifier (ID) and a transmission configuration indicator (TCI) state. The first cell is a cooperating cell, and the second cell is a serving cell.

### CROSS-REFERENCE TO RELATED APPLICATIONS

This application claims the benefit of KR Application No. 10-2021-0004503 filed on Jan. 13, 2021 which is hereby incorporated by reference as if fully set forth herein.

### TECHNICAL FIELD

The present disclosure relates to a wireless communication system, and more particularly, to a method and apparatus for transmitting/receiving a wireless signal.

### BACKGROUND

Generally, a wireless communication system is developing to diversely cover a wide range to provide such a communication service as an audio communication service, a data communication service and the like. The wireless communication is a sort of a multiple access system capable of supporting communications with multiple users by sharing available system resources (e.g., bandwidth, transmit power, etc.). For example, the multiple access system may be any of a code division multiple access (CDMA) system, a frequency division multiple access (FDMA) system, a time division multiple access (TDMA) system, an orthogonal frequency division multiple access (OFDMA) system, and a single carrier frequency division multiple access (SC-FDMA) system.

### SUMMARY

An object of the present disclosure is to provide a method of efficiently performing wireless signal transmission/reception procedures and an apparatus therefor.

It will be appreciated by persons skilled in the art that the objects and advantages that could be achieved with the present disclosure are not limited to what has been particularly described hereinabove and the above and other objects and advantages that the present disclosure could achieve will be more clearly understood from the following detailed description.

According to an embodiment of the present disclosure, a method of receiving a signal by a user equipment (UE) in a wireless communication system may include configuring a first transmission and reception point (TRP) using resources of a first cell, configuring a second TRP using resources of a second cell, receiving first downlink control information (DCI) scheduling a first physical uplink shared channel (PUSCH), receiving second DCI scheduling a second PUSCH, transmitting the first PUSCH to the first TRP, and transmitting the second PUSCH to the second TRP. The first DCI and the second DCI may include information about a hybrid automatic repeat request (HARQ) process identifier (ID) and a transmission configuration indicator (TCI) state. The first cell may be a cooperating cell, and the second cell may be a serving cell.

Alternatively, when the first DCI and the second DCI indicate the same HARQ process ID, the first PUSCH and the second PUSCH include the same transport block (TB).

Alternatively, the UE configures a medium access control (MAC) entity of the second cell, and the same TB is configured by the MAC entity of the second cell.

Alternatively, when the first DCI and the second DCI indicate different HARQ process IDs, the first PUSCH and the second PUSCH include different TBs.

Alternatively, the UE configures a MAC entity of the second cell, and the different TBs are configured by the MAC entity of the second cell.

Alternatively, the UE configures a MAC entity of the second cell, and

the different TBs are configured by the MAC entity of the second cell.

Alternatively, the same or different logical channels or priorities are mapped to the first TRP and the second TRP.

Alternatively, data having different qualities of service (QoSs) or priorities are included respectively in the different TBs configured by the HARQ entity of the first cell and the HARQ entity of the second cell.

Alternatively, an embodiment of the present disclosure discloses a non-transitory computer-readable medium recording a program code for performing the above method.

Alternatively, according to an embodiment of the present disclosure, a UE for receiving a signal in a wireless communication system includes a transceiver, and at least one processor coupled to the transceiver. The at least one processor is configured to configure a first TRP using resources of a first cell and a second TRP using resources of a second cell, receive first DCI scheduling a first PUSCH, receive second DCI scheduling a second PUSCH, transmit the first PUSCH to the first TRP, and transmit the second PUSCH to the second TRP.

Alternatively, The first DCI and the second DCI include information about an HARQ process ID and a TCI state. The first cell is a cooperating cell, and the second cell is a serving cell.

According to other aspect of the present disclosure, a non-transitory computer readable medium recorded thereon program codes for performing the aforementioned method is presented.

According to another aspect of the present disclosure, the UE configured to perform the aforementioned method is presented.

According to another aspect of the present disclosure, a device configured to control the UE to perform the aforementioned method is presented.

### BRIEF DESCRIPTION OF THE DRAWINGS

FIG. 1 illustrates physical channels used in a 3rd generation partnership project (3GPP) system, which is an example of wireless communication systems, and a general signal transmission method using the same;

FIG. 2 illustrates a radio frame structure;

FIG. 3 illustrates a resource grid of a slot;

FIG. 4 illustrates exemplary mapping of physical channels in a slot;

FIG. 5 is a diagram illustrating a signal flow for a physical downlink control channel (PDCCH) transmission and reception process;

FIG. 6 illustrates exemplary multi-beam transmission of an SSB;

FIG. 7 illustrates an exemplary method of indicating an actually transmitted SSB;

FIG. 8 illustrates an example of PRACH transmission in the NR system;

FIG. 9 illustrates an example of a RACH occasion defined in one RACH slot in the NR system;

FIGS. 10A to 10E illustrate various embodiments of the configurations of medium access control (MAC)/hybrid automatic repeat request (HARQ) entities of a user equipment (UE) and a next generation Node B (gNB), for inter-cell multi-transmission and reception point (MTRP) applicable to the present disclosure;

FIG. 11 illustrates an exemplary method of transmitting a downlink transport block (TB) for inter-cell MTRP according to a MAC/HARQ entity configuration, applicable to the present disclosure.

FIG. 12 illustrates another exemplary method of transmitting a downlink TB for inter-cell MTRP according to a MAC/HARQ entity configuration, applicable to the present disclosure.

FIG. 13 illustrates another exemplary method of transmitting a downlink TB for inter-cell MTRP according to a MAC/HARQ entity configuration, applicable to the present disclosure.

FIG. 14 illustrates an exemplary method of transmitting an uplink TB for inter-cell MTRP according to a MAC/HARQ entity configuration, applicable to the present disclosure.

FIG. 15 illustrates a method of receiving a signal by a UE in an embodiment of the present disclosure;

FIG. 16 to FIG. 19 illustrate a communication system 1 and wireless devices applied to the present disclosure; and

FIG. 20 illustrates an exemplary discontinuous reception (DRX) operation applied to the present disclosure.

### DETAILED DESCRIPTION

Embodiments of the present disclosure are applicable to a variety of wireless access technologies such as code division multiple access (CDMA), frequency division multiple access (FDMA), time division multiple access (TDMA), orthogonal frequency division multiple access (OFDMA), and single carrier frequency division multiple access (SC-FDMA). CDMA can be implemented as a radio technology such as Universal Terrestrial Radio Access (UTRA) or CDMA2000. TDMA can be implemented as a radio technology such as Global System for Mobile communications (GSM)/General Packet Radio Service (GPRS)/Enhanced Data Rates for GSM Evolution (EDGE). OFDMA can be implemented as a radio technology such as Institute of Electrical and Electronics Engineers (IEEE) 802.11 (Wireless Fidelity (Wi-Fi)), IEEE 802.16 (Worldwide interoperability for Microwave Access (WiMAX)), IEEE 802.20, and Evolved UTRA (E-UTRA). UTRA is a part of Universal Mobile Telecommunications System (UMTS). 3rd Generation Partnership Project (3GPP) Long Term Evolution (LTE) is part of Evolved UMTS (E-UMTS) using E-UTRA, and LTE-Advanced (A) is an evolved version of 3GPP LTE. 3GPP NR (New Radio or New Radio Access Technology) is an evolved version of 3GPP LTE/LTE-A.

As more and more communication devices require a larger communication capacity, there is a need for mobile broadband communication enhanced over conventional radio access technology (RAT). In addition, massive Machine Type Communications (MTC) capable of providing a variety of services anywhere and anytime by connecting multiple devices and objects is another important issue to be considered for next generation communications. Communication system design considering services/UEs sensitive to reliability and latency is also under discussion. As such, introduction of new radio access technology considering enhanced mobile broadband communication (eMBB), massive MTC, and Ultra-Reliable and Low Latency Communication (URLLC) is being discussed. In the present disclosure, for simplicity, this technology will be referred to as NR (New Radio or New RAT).

For the sake of clarity, 3GPP NR is mainly described, but the technical idea of the present disclosure is not limited thereto.

Details of the background, terminology, abbreviations, etc. used herein may be found in 3GPP standard documents published before the present disclosure.

Following documents are incorporated by reference:

3GPP LTE
TS 36.211: Physical channels and modulation
TS 36.212: Multiplexing and channel coding
TS 36.213: Physical layer procedures
TS 36.300: Overall description
TS 36.321: Medium Access Control (MAC)
TS 36.331: Radio Resource Control (RRC)

3GPP NR
TS 38.211: Physical channels and modulation
TS 38.212: Multiplexing and channel coding
TS 38.213: Physical layer procedures for control
TS 38.214: Physical layer procedures for data
TS 38.300: NR and NG-RAN Overall Description
TS 38.321: Medium Access Control (MAC)
TS 38.331: Radio Resource Control (RRC) protocol specification

Abbreviations and Terms
PDCCH: Physical Downlink Control CHannel
PDSCH: Physical Downlink Shared CHannel
PUSCH: Physical Uplink Shared CHannel
CSI: Channel state information
RRM: Radio resource management
RLM: Radio link monitoring
DCI: Downlink Control Information
CAP: Channel Access Procedure
Ucell: Unlicensed cell
PCell: Primary Cell
PSCell: Primary SCG Cell
TBS: Transport Block Size
TRP: Transmission/Reception Point
SLIV: Starting and Length Indicator Value
BWP: BandWidth Part
CORESET: COntrol REsourse SET
REG: Resource element group
SFI: Slot Format Indicator
COT: Channel occupancy time
SPS: Semi-persistent scheduling
PLMN ID: Public Land Mobile Network identifier
RACH: Random Access Channel
RAR: Random Access Response
Msg3: Message transmitted on UL-SCH containing a C-RNTI MAC CE or CCCH SDU, submitted from upper layer and associated with the UE Contention Resolution Identity, as part of a Random Access procedure.
Special Cell: For Dual Connectivity operation the term Special Cell refers to the PCell of the MCG or the PSCell of the SCG depending on if the MAC entity is associated to the MCG or the SCG, respectively. Otherwise the term Special Cell refers to the PCell. A Special Cell supports PUCCH transmission and contention-based Random Access, and is always activated.
Serving Cell: A PCell, a PSCell, or an SCell

In a wireless communication system, a user equipment (UE) receives information through downlink (DL) from a base station (BS) and transmit information to the BS through uplink (UL). The information transmitted and received by the BS and the UE includes data and various control information and includes various physical channels according to type/usage of the information transmitted and received by the UE and the BS.

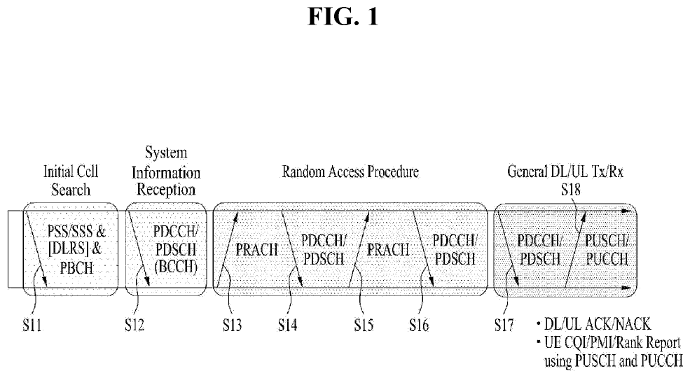

FIG. 1 illustrates physical channels used in a 3GPP NR system and a general signal transmission method using the same.

When a UE is powered on again from a power-off state or enters a new cell, the UE performs an initial cell search procedure, such as establishment of synchronization with a BS, in step S101. To this end, the UE receives a synchronization signal block (SSB) from the BS. The SSB includes a primary synchronization signal (PSS), a secondary synchronization signal (SSS), and a physical broadcast channel (PBCH). The UE establishes synchronization with the BS based on the PSS/SSS and acquires information such as a cell identity (ID). The UE may acquire broadcast information in a cell based on the PBCH. The UE may receive a DL reference signal (RS) in an initial cell search procedure to monitor a DL channel status.

After initial cell search, the UE may acquire more specific system information by receiving a physical downlink control channel (PDCCH) and receiving a physical downlink shared channel (PDSCH) based on information of the PDCCH in step S102.

The UE may perform a random access procedure to access the BS in steps S103 to S106. For random access, the UE may transmit a preamble to the BS on a physical random access channel (PRACH) (S103) and receive a response message for preamble on a PDCCH and a PDSCH corresponding to the PDCCH (S104). In the case of contention-based random access, the UE may perform a contention resolution procedure by further transmitting the PRACH (S105) and receiving a PDCCH and a PDSCH corresponding to the PDCCH (S106).

After the foregoing procedure, the UE may receive a PDCCH/PDSCH (S107) and transmit a physical uplink shared channel (PUSCH)/physical uplink control channel (PUCCH) (S108), as a general downlink/uplink signal transmission procedure. Control information transmitted from the UE to the BS is referred to as uplink control information (UCI). The UCI includes hybrid automatic repeat and request acknowledgement/negative-acknowledgement (HARQ-ACK/NACK), scheduling request (SR), channel state information (CSI), etc. The CSI includes a channel quality indicator (CQI), a precoding matrix indicator (PMI), a rank indicator (RI), etc. While the UCI is transmitted on a PUCCH in general, the UCI may be transmitted on a PUSCH when control information and traffic data need to be simultaneously transmitted. In addition, the UCI may be aperiodically transmitted through a PUSCH according to request/command of a network.

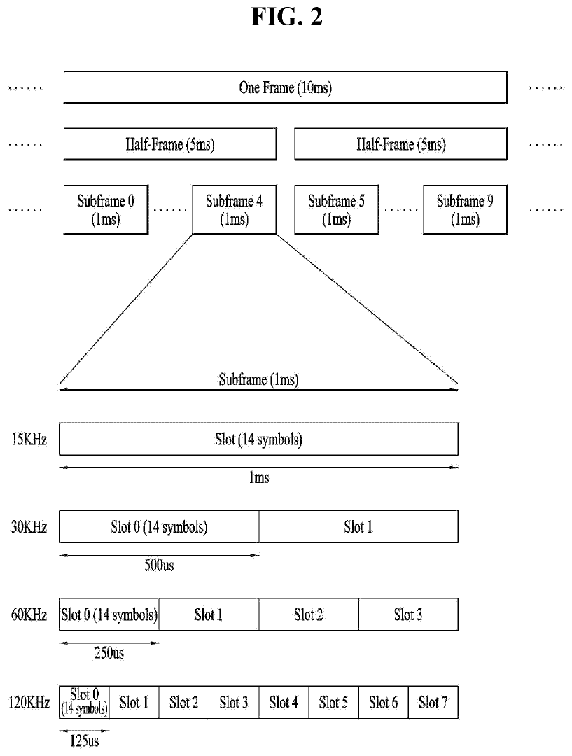

FIG. 2 illustrates a radio frame structure. In NR, uplink and downlink transmissions are configured with frames. Each radio frame has a length of 10 ms and is divided into two 5-ms half-frames (HF). Each half-frame is divided into five 1-ms subframes (SFs). A subframe is divided into one or more slots, and the number of slots in a subframe depends on subcarrier spacing (SCS). Each slot includes 12 or 14 Orthogonal Frequency Division Multiplexing (OFDM) symbols according to a cyclic prefix (CP). When a normal CP is used, each slot includes 14 OFDM symbols. When an extended CP is used, each slot includes 12 OFDM symbols.

Table 1 exemplarily shows that the number of symbols per slot, the number of slots per frame, and the number of slots per subframe vary according to the SCS when the normal CP is used.

TABLE 1

| SCS (15*2^{u}) | N^{slot}_{symb} | N^{frame, u}ₛₗₒₜ | N^{subframe, u}ₛₗₒₜ |
|---|---|---|---|
| 15 KHz (u = 0) | 14 | 10 | 1 |
| 30 KHz (u = 1) | 14 | 20 | 2 |
| 60 KHz (u = 2) | 14 | 40 | 4 |
| 120 KHz (u = 3) | 14 | 80 | 8 |
| 240 KHz (u = 4) | 14 | 160 | 16 |

* N^{slot}_{symb}: Number of symbols in a slot
* N^{frame, u}ₛₗₒₜ: Number of slots in a frame
* N^{subframe, u}ₛₗₒₜ: Number of slots in a subframe

Table 2 illustrates that the number of symbols per slot, the number of slots per frame, and the number of slots per subframe vary according to the SCS when the extended CP is used.

TABLE 2

| SCS (15*2^{u}) | N^{slot}_{symb} | N^{frame, u}ₛₗₒₜ | N^{subrame, u}ₛₗₒₜ |
|---|---|---|---|
| 60 KHz (u = 2) | 12 | 40 | 4 |

The structure of the frame is merely an example. The number of subframes, the number of slots, and the number of symbols in a frame may vary.

In the NR system, OFDM numerology (e.g., SCS) may be configured differently for a plurality of cells aggregated for one UE. Accordingly, the (absolute time) duration of a time resource (e.g., an SF, a slot or a TTI) (for simplicity, referred to as a time unit (TU)) consisting of the same number of symbols may be configured differently among the aggregated cells. Here, the symbols may include an OFDM symbol (or a CP-OFDM symbol) and an SC-FDMA symbol (or a discrete Fourier transform-spread-OFDM (DFT-s-OFDM) symbol).

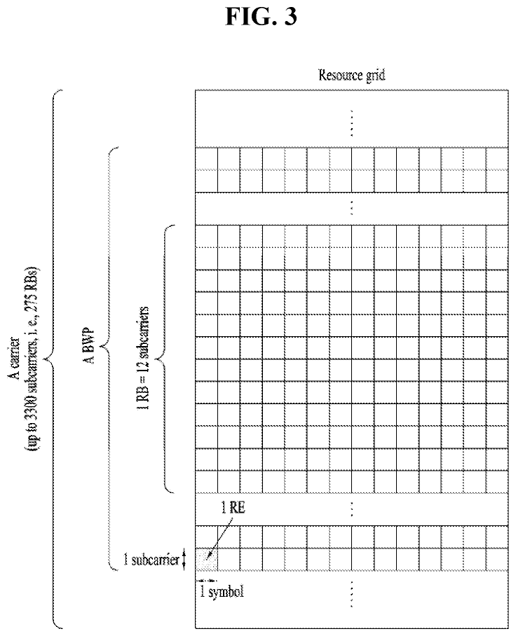

FIG. 3 illustrates a resource grid of a slot. A slot includes a plurality of symbols in the time domain. For example, when the normal CP is used, the slot includes 14 symbols. However, when the extended CP is used, the slot includes 12 symbols. A carrier includes a plurality of subcarriers in the frequency domain. A resource block (RB) is defined as a plurality of consecutive subcarriers (e.g., 12 consecutive subcarriers) in the frequency domain. A bandwidth part (BWP) may be defined to be a plurality of consecutive physical RBs (PRBs) in the frequency domain and correspond to a single numerology (e.g., SCS, CP length, etc.). The carrier may include up to N (e.g., 5) BWPs. Data communication may be performed through an activated BWP, and only one BWP may be activated for one UE. In the resource grid, each element is referred to as a resource element (RE), and one complex symbol may be mapped to each RE.

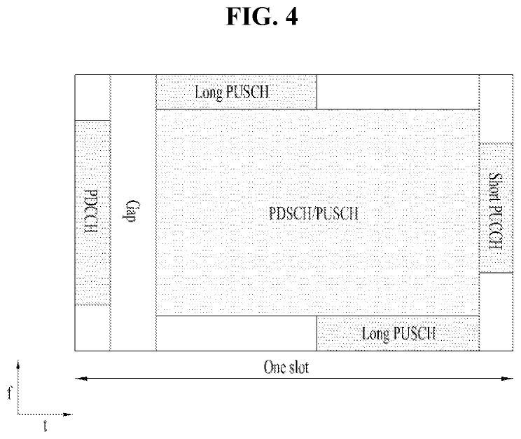

FIG. 4 illustrates exemplary mapping of physical channels in a slot. In the NR system, a DL control channel, DL or UL data, and a UL control channel may be included in one slot. For example, the first N symbols (hereinafter, referred to as a DL control region) of a slot may be used to transmit a DL control channel (e.g., PDCCH), and the last M symbols (hereinafter, referred to as a UL control region) of the slot may be used to transmit a UL control channel (e.g., PUCCH). Each of N and M is an integer equal to or larger than 0. A resource region (hereinafter, referred to as a data region) between the DL control region and the UL control region may be used to transmit DL data (e.g., PDSCH) or UL data (e.g., PUSCH). A guard period (GP) provides a time gap for transmission mode-to-reception mode switching or reception mode-to-transmission mode switching at a BS and a UE. Some symbol at the time of DL-to-UL switching in a subframe may be configured as a GP.

The PDCCH delivers DCI. For example, the PDCCH (i.e., DCI) may carry information about a transport format and resource allocation of a DL shared channel (DL-SCH), resource allocation information of an uplink shared channel (UL-SCH), paging information on a paging channel (PCH), system information on the DL-SCH, information on resource allocation of a higher-layer control message such as an RAR transmitted on a PDSCH, a transmit power control command, information about activation/release of configured scheduling, and so on. The DCI includes a cyclic redundancy check (CRC). The CRC is masked with various identifiers (IDs) (e.g. a radio network temporary identifier (RNTI)) according to an owner or usage of the PDCCH. For example, if the PDCCH is for a specific UE, the CRC is masked by a UE ID (e.g., cell-RNTI (C-RNTI)). If the PDCCH is for a paging message, the CRC is masked by a paging-RNTI (P-RNTI). If the PDCCH is for system information (e.g., a system information block (SIB)), the CRC is masked by a system information RNTI (SI-RNTI). When the PDCCH is for an RAR, the CRC is masked by a random access-RNTI (RA-RNTI).

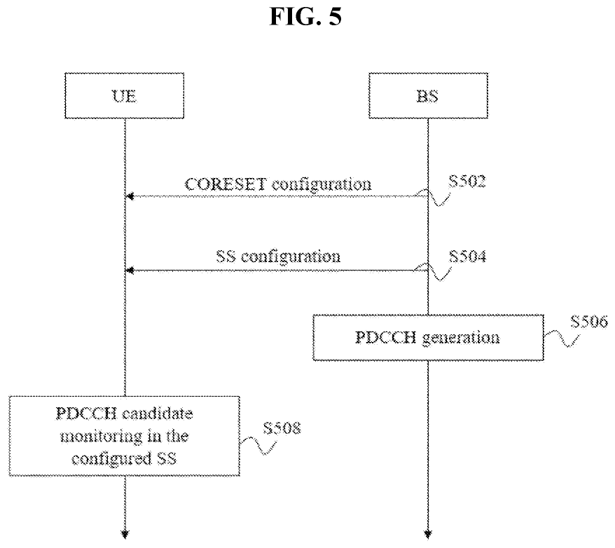

FIG. 5 is a diagram illustrating a signal flow for a PDCCH transmission and reception process.

Referring to FIG. 5, a BS may transmit a control resource set (CORESET) configuration to a UE (S502). A CORSET is defined as a resource element group (REG) set having a given numerology (e.g., an SCS, a CP length, and so on). An REG is defined as one OFDM symbol by one (P)RB. A plurality of CORESETs for one UE may overlap with each other in the time/frequency domain. A CORSET may be configured by system information (e.g., a master information block (MIB)) or higher-layer signaling (e.g., radio resource control (RRC) signaling). For example, configuration information about a specific common CORSET (e.g., CORESET #0) may be transmitted in an MIB. For example, a PDSCH carrying system information block 1 (SIB1) may be scheduled by a specific PDCCH, and CORSET #0 may be used to carry the specific PDCCH. Configuration information about CORESET #N (e.g., N>0) may be transmitted by RRC signaling (e.g., cell-common RRC signaling or UE-specific RRC signaling). For example, the UE-specific RRC signaling carrying the CORSET configuration information may include various types of signaling such as an RRC setup message, an RRC reconfiguration message, and/or BWP configuration information. Specifically, a CORSET configuration may include the following information/fields.
controlResourceSetId: indicates the ID of a CORESET.
frequencyDomainResources: indicates the frequency resources of the CORESET. The frequency resources of the CORESET are indicated by a bitmap in which each bit corresponds to an RBG (e.g., six (consecutive) RBs). For example, the most significant bit (MSB) of the bitmap corresponds to a first RBG. RBGs corresponding to bits set to 1 are allocated as the frequency resources of the CORESET.
duration: indicates the time resources of the CORESET. Duration indicates the number of consecutive OFDM symbols included in the CORESET. Duration has a value of 1 to 3.
cce-REG-MappingType: indicates a control channel element (CCE)-REG mapping type. Interleaved and non-interleaved types are supported.
interleaverSize: indicates an interleaver size.
pdcch-DMRS-ScramblingID: indicates a value used for PDCCH DMRS initialization. When pdcch-DMRS-ScramblingID is not included, the physical cell ID of a serving cell is used.
precoderGranularity: indicates a precoder granularity in the frequency domain.
reg-BundleSize: indicates an REG bundle size.
tci-PresentInDCI: indicates whether a transmission configuration index (TCI) field is included in DL-related DCI.
tci-StatesPDCCH-ToAddList: indicates a subset of TCI states configured in pdcch-Config, used for providing quasi-co-location (QCL) relationships between DL RS(s) in an RS set (TCI-State) and PDCCH DMRS ports.

Further, the BS may transmit a PDCCH search space (SS) configuration to the UE (S504). The PDCCH SS configuration may be transmitted by higher-layer signaling (e.g., RRC signaling). For example, the RRC signaling may include, but not limited to, various types of signaling such as an RRC setup message, an RRC reconfiguration message, and/or BWP configuration information. While a CORESET configuration and a PDCCH SS configuration are shown in FIG. 5 as separately signaled, for convenience of description, the present disclosure is not limited thereto. For example, the CORESET configuration and the PDCCH SS configuration may be transmitted in one message (e.g., by one RRC signaling) or separately in different messages.

The PDCCH SS configuration may include information about the configuration of a PDCCH SS set. The PDCCH SS set may be defined as a set of PDCCH candidates monitored (e.g., blind-detected) by the UE. One or more SS sets may be configured for the UE. Each SS set may be a USS set or a CSS set. For convenience, PDCCH SS set may be referred to as “SS” or “PDCCH SS”.

A PDCCH SS set includes PDCCH candidates. A PDCCH candidate is CCE(s) that the UE monitors to receive/detect a PDCCH. The monitoring includes blind decoding (BD) of PDCCH candidates. One PDCCH (candidate) includes 1, 2, 4, 8, or 16 CCEs according to an aggregation level (AL). One CCE includes 6 REGs. Each CORESET configuration is associated with one or more SSs, and each SS is associated with one CORESET configuration. One SS is defined based on one SS configuration, and the SS configuration may include the following information/fields.
searchSpaceId: indicates the ID of an SS.
controlResourceSetId: indicates a CORESET associated with the SS.
monitoringSlotPeriodicityAndOffset: indicates a periodicity (in slots) and offset (in slots) for PDCCH monitoring.
monitoringSymbolsWithinSlot: indicates the first OFDM symbol(s) for PDCCH monitoring in a slot configured with PDCCH monitoring. The first OFDM symbol(s) for PDCCH monitoring is indicated by a bitmap with each bit corresponding to an OFDM symbol in the slot. The MSB of the bitmap corresponds to the first OFDM symbol of the slot. OFDM symbol(s) corresponding to bit(s) set to 1 corresponds to the first symbol(s) of a CORESET in the slot.
nrofCandidates: indicates the number of PDCCH candidates (one of values 0, 1, 2, 3, 4, 5, 6, and 8) for each AL where AL={1, 2, 4, 8, 16}.
searchSpaceType: indicates common search space (CSS) or UE-specific search space (USS) as well as a DCI format used in the corresponding SS type.

Subsequently, the BS may generate a PDCCH and transmit the PDCCH to the UE (S506), and the UE may monitor PDCCH candidates in one or more SSs to receive/detect the PDCCH (S508). An occasion (e.g., time/frequency resources) in which the UE is to monitor PDCCH candidates is defined as a PDCCH (monitoring) occasion. One or more PDCCH (monitoring) occasions may be configured in a slot.

Table 3 shows the characteristics of each SS.

TABLE 3

| Type | Search Space | RNTI | Use Case |
|---|---|---|---|
| Type0-PDCCH | Common | SI-RNTI on a primary cell | SIB Decoding |
| Type0A-PDCCH | Common | SI-RNTI on a primary cell | SIB Decoding |
| Type1-PDCCH | Common | RA-RNTI or TC-RNTI on a primary cell | Msg2, Msg4 |
| | | | decoding in |
| | | | RACH |
| Type2-PDCCH | Common | P-RNTI on a primary cell | Paging |
| | | | Decoding |
| Type3-PDCCH | Common | INT-RNTI, SFI-RNTI, TPC-PUSCH-RNTI, | |
| | | TPC-PUCCH-RNTI, TPC-SRS-RNTI, C-RNTI, | |
| | | MCS-C-RNTI, or CS-RNTI(s) | |
| | UE | C-RNTI, or MCS-C-RNTI, or CS-RNTI(s) | User specific |
| | Specific | | PDSCH |
| | | | decoding |

Table 4 shows DCI formats transmitted on the PDCCH.

TABLE 4

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM |
| | symbol(s) where UE may assume no transmission is |
| | intended for the UE |
| 2_2 | Transmission of TPC commands for PUCCH and PUSCH |
| 2_3 | Transmission of a group of TPC commands for SRS |
| | transmissions by one or more UEs |

DCI format 0_0 may be used to schedule a TB-based (or TB-level) PUSCH, and DCI format 0_1 may be used to schedule a TB-based (or TB-level) PUSCH or a code block group (CBG)-based (or CBG-level) PUSCH. DCI format 1_0 may be used to schedule a TB-based (or TB-level) PDSCH, and DCI format 1_1 may be used to schedule a TB-based (or TB-level) PDSCH or a CBG-based (or CBG-level) PDSCH (DL grant DCI). DCI format 0_0/0_1 may be referred to as UL grant DCI or UL scheduling information, and DCI format 1_0/1_1 may be referred to as DL grant DCI or DL scheduling information. DCI format 2_0 is used to deliver dynamic slot format information (e.g., a dynamic slot format indicator (SFI)) to a UE, and DCI format 2_1 is used to deliver DL pre-emption information to a UE. DCI format 2_0 and/or DCI format 2_1 may be delivered to a corresponding group of UEs on a group common PDCCH which is a PDCCH directed to a group of UEs.

DCI format 0_0 and DCI format 1_0 may be referred to as fallback DCI formats, whereas DCI format 0_1 and DCI format 1_1 may be referred to as non-fallback DCI formats. In the fallback DCI formats, a DCI size/field configuration is maintained to be the same irrespective of a UE configuration. In contrast, the DCI size/field configuration varies depending on a UE configuration in the non-fallback DCI formats.

A CCE-to-REG mapping type is set to one of an interleaved type and a non-interleaved type.
Non-interleaved CCE-to-REG mapping (or localized CCE-to-REG mapping): 6 REGs for a given CCE are grouped into one REG bundle, and all of the REGs for the given CCE are contiguous. One REG bundle corresponds to one CCE.
Interleaved CCE-to-REG mapping (or distributed CCE-to-REG mapping): 2, 3 or 6 REGs for a given CCE are grouped into one REG bundle, and the REG bundle is interleaved within a CORESET. In a CORESET including one or two OFDM symbols, an REG bundle includes 2 or 6 REGs, and in a CORESET including three OFDM symbols, an REG bundle includes 3 or 6 REGs. An REG bundle size is configured on a CORESET basis.

System Information Acquisition

A UE may acquire AS-/NAS-information in the SI acquisition process. The SI acquisition process may be applied to UEs in RRC_IDLE state, RRC_INACTIVE state, and RRC_CONNECTED state.

SI is divided into a master information block (MIB) and a plurality of system information blocks (SIBs). The SI except for the MIB may be referred to as remaining minimum system information (RMS) and other system information (OSI). RMSI corresponds to SIB1, and OSI refers to SIBs of SIB2 or higher other than SIB1. For details, reference may be made to the followings.
The MIB includes information/parameters related to reception of systemInformaitonBlockType1 (SIB1) and is transmitted on a PBCH of an SSB. MIB information may include the following fields.
pdcch-ConfigSIB1: Determines a common ControlResourceSet (CORESET), a common search space and necessary PDCCH parameters. If the field ssb-SubcarrierOffset indicates that SIB1 is absent, the field pdcch-ConfigSIB1 indicates the frequency positions where the UE may find SS/PBCH block with SIB1 or the frequency range where the network does not provide SS/PBCH block with SIB1.
ssb-SubcarrierOffset: Corresponds to kSSB which is the frequency domain offset between SSB and the overall resource block grid in number of subcarriers. The value range of this field may be extended by an additional most significant bit encoded within PBCH. This field may indicate that this cell does not provide SIB1 and that there is hence no CORESET#0 configured in MIB. In this case, the field pdcch-ConfigSIB1 may indicate the frequency positions where the UE may (not) find a SS/PBCH with a control resource set and search space for SIB1.
subCarrierSpacingCommon: Subcarrier spacing for SIB1, Msg.2/4 for initial access, paging and broadcast SI-messages. If the UE acquires this MIB on an FR1 carrier frequency, the value scs15or60 corresponds to 15 kHz and the value scs30or120 corresponds to 30 kHz. If the UE acquires this MIB on an FR2 carrier frequency, the value scs15or60 corresponds to 60 kHz and the value scs30or120 corresponds to 120 kHz.

In initial cell selection, the UE may determine whether there is a control resource set (CORESET) for a Type0-PDCCH common search space based on the MIB. The Type0-PDCCH common search space is a kind of a PDCCH search space, and is used to transmit a PDCCH scheduling an SI message. In the presence of a Type0-PDCCH common search space, the UE may determine (i) a plurality of consecutive RBs and one or more consecutive symbols in a CORESET and (ii) PDCCH occasions (i.e., time-domain positions for PDCCH reception), based on information (e.g., pdcch-ConfigSIB1) in the MIB. Specifically, pdcch-ConfigSIB1 is 8-bit information, (i) is determined based on the most significant bits (MSB) of 4 bits, and (ii) is determined based on the least significant bits (LSB) of 4 bits.

In the absence of any Type0-PDCCH common search space, pdcch-ConfigSIB1 provides information about the frequency position of an SSB/SIB1 and a frequency range free of an SSB/SIB.

For initial cell selection, a UE may assume that half frames with SS/PBCH blocks occur with a periodicity of 2 frames. Upon detection of a SS/PBCH block, the UE determines that a control resource set for Type0-PDCCH common search space is present if k_{SSB}≤23 for FR1 (Frequency Range 1; Sub-6 GHz; 450 to 6000 MHz) and if k_{SSB}<11 for FR2 (Frequency Range 2; mm-Wave; 24250 to 52600 MHz). The UE determines that a control resource set for Type0-PDCCH common search space is not present if k_{SSB}>23 for FR1 and if k_{SSB}>11 for FR2. k_{SSB} represents a frequency/subcarrier offset between subcarrier 0 of SS/PBCH block to subcarrier 0 of common resource block for SSB. For FR2 only values up to 11 are applicable. k_{SSB} may be signaled through the MIB.
SIB1 includes information related to the availability and scheduling (e.g., a transmission periodicity and an SI-window size) of the other SIBs (hereinafter, referred to as SIBx where x is an integer equal to or larger than 2). For example, SIB1 may indicate whether SIBx is broadcast periodically or provided by an UE request in an on-demand manner When SIBx is provided in the on-demand manner, SIB1 may include information required for the UE to transmit an SI request. SIB1 is transmitted on a PDSCH, and a PDCCH scheduling SIB1 is transmitted in a Type0-PDCCH common search space. SIB1 is transmitted on a PDSCH indicated by the PDCCH.
SIBx is included in an SI message and transmitted on a PDSCH. Each SI message is transmitted within a time window (i.e., an SI-window) which takes place periodically.

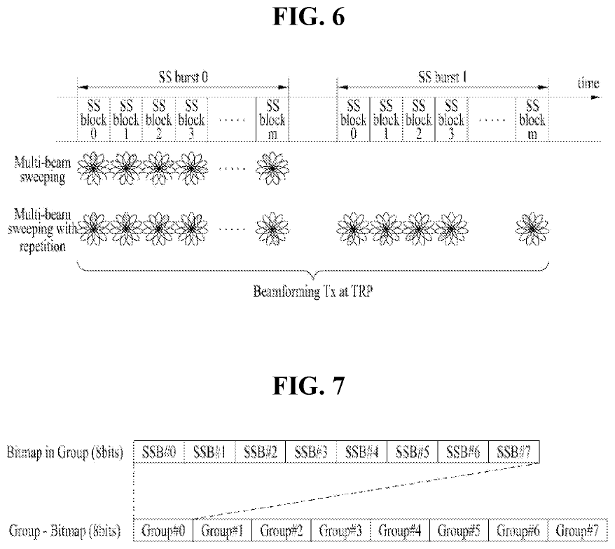

FIG. 6 illustrates exemplary multi-beam transmission of an SSB. Beam sweeping refers to changing the beam (direction) of a wireless signal over time at a transmission reception point (TRP) (e.g., a BS/cell) (hereinbelow, the terms beam and beam direction are interchangeably used). An SSB may be transmitted periodically by beam sweeping. In this case, SSB indexes are implicitly linked to SSB beams. An SSB beam may be changed on an SSB (index) basis. The maximum transmission number L of an SSB in an SSB burst set is 4, 8 or 64 according to the frequency band of a carrier. Accordingly, the maximum number of SSB beams in the SSB burst set may be given according to the frequency band of a carrier as follows.
For frequency range up to 3 GHz, Max number of beams=4
For frequency range from 3 GHz to 6 GHz, Max number of beams=8
For frequency range from 6 GHz to 52.6 GHz, Max number of beams=64
* Without multi-beam transmission, the number of SS/PBCH block beams is 1.

When a UE attempts initial access to a BS, the UE may perform beam alignment with the BS based on an SS/PBCH block. For example, after SS/PBCH block detection, the UE identifies a best SS/PBCH block. Subsequently, the UE may transmit an RACH preamble to the BS in PRACH resources linked/corresponding to the index (i.e., beam) of the best SS/PBCH block. The SS/PBCH block may also be used in beam alignment between the BS and the UE after the initial access.

FIG. 7 illustrates an exemplary method of indicating an actually transmitted SSB (SSB_tx). Up to L SS/PBCH blocks may be transmitted in an SS/PBCH block burst set, and the number/positions of actually transmitted SS/PBCH blocks may be different for each BS/cell. The number/positions of actually transmitted SS/PBCH blocks are used for rate-matching and measurement, and information about actually transmitted SS/PBCH blocks is indicated as follows.
If the information is related to rate-matching: the information may be indicated by UE-specific RRC signaling or remaining minimum system information (RMSI). The UE-specific RRC signaling includes a full bitmap (e.g., of length L) for frequency ranges below and above 6 GHz. The RMSI includes a full bitmap for a frequency range below 6 GHz and a compressed bitmap for a frequency range above 6 GHz, as illustrated. Specifically, the information about actually transmitted SS/PBCH blocks may be indicated by a group-bitmap (8 bits)+an in-group bitmap (8 bits). Resources (e.g., REs) indicated by the UE-specific RRC signaling or the RMSI may be reserved for SS/PBCH block transmission, and a PDSCH/PUSCH may be rate-matched in consideration of the SS/PBCH block resources.
If the information is related to measurement: the network (e.g., BS) may indicate an SS/PBCH block set to be measured within a measurement period, when the UE is in RRC connected mode. The SS/PBCH block set may be indicated for each frequency layer. Without an indication of an SS/PBCH block set, a default SS/PBCH block set is used. The default SS/PBCH block set includes all SS/PBCH blocks within the measurement period. An SS/PBCH block set may be indicated by a full bitmap (e.g., of length L) in RRC signaling. When the UE is in RRC idle mode, the default SS/PBCH block set is used.

Random Access Operation and Related Operation

When there is no PUSCH transmission resource (i.e., uplink grant) allocated by the BS, the UE may perform a random access operation. Random access of the NR system can occur 1) when the UE requests or resumes the RRC connection, 2) when the UE performs handover or secondary cell group addition (SCG addition) to a neighboring cell, 3) when a scheduling request is made to the BS, 4) when the BS indicates random access of the UE in PDCCH order, or 5) when a beam failure or RRC connection failure is detected.

The RACH procedure of LTE and NR consists of 4 steps of Msg1 (PRACH preamble) transmission from the UE, Msg2 (RAR, random access response) transmission from the BS, Msg3 (PUSCH) transmission from the UE, and Msg4 (PDSCH) transmission from the BS. That is, the UE transmits a physical random access channel (PRACH) preamble and receives an RAR as a response thereto. When the preamble is a UE-dedicated resource, that is, in the case of contention free random access (CFRA), the random access operation is terminated by receiving the RAR corresponding to the UE itself. If the preamble is a common resource, that is, in the case of contention based random access (CBRA), after the RAR including an uplink PUSCH resource and a RACH preamble ID (RAPID) selected by the UE is received, Msg3 is transmitted through a corresponding resource on the PUSCH. And after a contention resolution message is received on the PDSCH, the random access operation is terminated. In this case, a time and frequency resources to/on which the PRACH preamble signal is mapped/transmitted is defined as RACH occasion (RO), and a time and frequency resource to/on which the Msg3 PUSCH signal is mapped/transmitted is defined as PUSCH occasion (PO).

In Rel. 16 In NR and NR-U, a 2-step RACH procedure has been introduced, which is a reduced procedure for the 4-step RACH procedure. The 2-step RACH procedure is composed of MsgA (PRACH preamble+Msg3 PUSCH) transmission from the UE and MsgB (RAR+Msg4 PDSCH) transmission from the gNB.

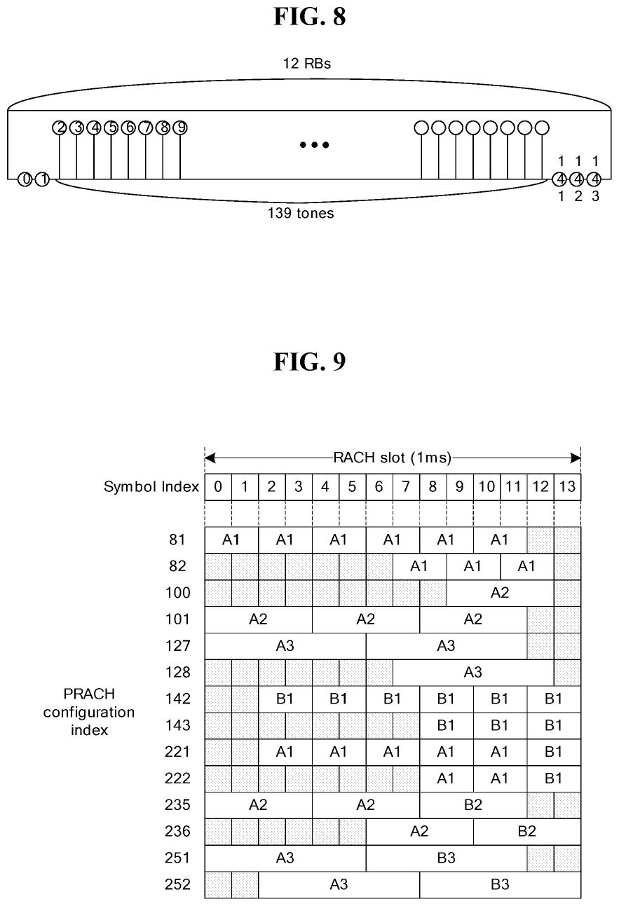

The PRACH format for transmitting the PRACH preamble in the NR system consists of a format composed of a length 839 sequence (named as a long RACH format for simplicity) and a format composed of a length 139 sequence (named as a short RACH format for simplicity). For example, in frequency range 1 (FR1), the sub-carrier spacing (SCS) of the short RACH format is defined as 15 or 30 kHz. Also, as shown in FIG. 8, RACH can be transmitted on 139 tones among 12 RBs (144 REs). In FIG. 8, 2 null tones are assumed for the lower RE index and 3 null tones are assumed for the upper RE index, but the positions may be changed.

The above-mentioned short PRACH format comprises values defined in Table 5. Here, μ is defined as one of {0, 1, 2, 3} according to the value of subcarrier spacing. For example, in the case of 15 kHz subcarrier spacing, μ is 0. In the case of 30 kHz subcarrier spacing, μ is 1. Table 5 shows Preamble formats for L_{RA}=139 and Δf^{RA}=15×2^{μ} kHz, where μ ∈{0,1,2,3}, κ=Tₛ/T_{c}=64.

TABLE 5

| Format | L_{RA} | Δf^{RA} | Nᵤ | N_{CP}^{RA} |
|---|---|---|---|---|
| A1 | 139 | 15 × 2^{μ} kHz | 2 × 2048κ × 2^{-μ} | 288κ × 2^{-μ} |
| A2 | 139 | 15 × 2^{μ} kHz | 4 × 2048κ × 2^{-μ} | 576κ × 2^{-μ} |
| A3 | 139 | 15 × 2^{μ} kHz | 6 × 2048κ × 2^{-μ} | 864κ × 2^{-μ} |
| B1 | 139 | 15 × 2^{μ} kHz | 2 × 2048κ × 2^{-μ} | 216κ × 2^{-μ} |
| B2 | 139 | 15 × 2^{μ} kHz | 4 × 2048κ × 2^{-μ} | 360κ × 2^{-μ} |
| B3 | 139 | 15 × 2^{μ} kHz | 6 × 2048κ × 2^{-μ} | 504κ × 2^{-μ} |
| B4 | 139 | 15 × 2^{μ} kHz | 12 × 2048κ × 2^{-μ} | 936κ × 2^{-μ} |
| C0 | 139 | 15 × 2^{μ} kHz | 2048κ × 2^{-μ} | 1240κ × 2^{-μ} |
| C2 | 139 | 15 × 2^{μ} kHz | 4 × 2048κ × 2^{-μ} | 2048κ × 2^{-μ} |

The BS can announce which PRACH format can be transmitted as much as a specific duration at a specific timing through higher layer signaling (RRC signaling or MAC CE or DCI, etc.) and how many ROs (RACH occasions or PRACH occasions) are in the slot. Table 6 shows a part of PRACH configuration indexes that can use A1, A2, A3, B1, B2, B3.

TABLE 6

| | | | | | | | Nₜ^{RA, slot}, | |
|---|---|---|---|---|---|---|---|---|
| | | | | | | | number of | |
| | | | | | | Number of | time-domain | |
| | | | | | | PRACH | PRACH | |
| PRACH | | n_{SFN}mod | | | | slots | occasions | N_{dur}^{RA}, |
| Configuration | Preamble | x = y | | Subframe | Starting | within a | within a | PRACH |
| Index | format | x | y | number | symbol | subframe | PRACH slot | duration |
| 81 | A1 | 1 | 0 | 4.9 | 0 | 1 | 6 | 2 |
| 82 | A1 | 1 | 0 | 7.9 | 7 | 1 | 3 | 2 |
| 100 | A2 | 1 | 0 | 9 | 9 | 1 | 1 | 4 |
| 101 | A2 | 1 | 0 | 9 | 0 | 1 | 3 | 4 |
| 127 | A3 | 1 | 0 | 4.9 | 0 | 1 | 2 | 6 |
| 128 | A3 | 1 | 0 | 7.9 | 7 | 1 | 1 | 6 |
| 142 | B1 | 1 | 0 | 4.9 | 2 | 1 | 6 | 2 |
| 143 | B1 | 1 | 0 | 7.9 | 8 | 1 | 3 | 2 |
| 221 | A1/B1 | 1 | 0 | 4.9 | 2 | 1 | 6 | 2 |
| 222 | A1/B1 | 1 | 0 | 7.9 | 8 | 1 | 3 | 2 |
| 235 | A2/B2 | 1 | 0 | 4.9 | 0 | 1 | 3 | 4 |
| 236 | A2/B2 | 1 | 0 | 7.9 | 6 | 1 | 2 | 4 |
| 251 | A3/B3 | 1 | 0 | 4.9 | 0 | 1 | 2 | 6 |
| 252 | A3/B3 | 1 | 0 | 7.9 | 2 | 1 | 2 | 6 |

Referring to Table 6, information about the number of ROs defined in a RACH slot for each preamble format (i.e., Nₜ^{RA, slot}: number of time-domain PRACH occasions within a PRACH slot), and the number of OFDM symbols occupied by each PRACH preamble for the preamble format (i.e., N_{dur}^{RA}, PRACH duration) can be known. In addition, by indicating the starting symbol of the first RO, information about the time at which the RO starts in the RACH slot can also be provided. FIG. 9 shows the configuration of the ROs in the RACH slot according to the PRACH configuration index values shown in Table 6.

Cooperative Transmission from Multiple TRPs/Panels/Beams

Coordinated multi-point (CoMP) is a technique in which a plurality of BSs cooperatively transmit signals to a UE by exchanging feedback channel information (e.g., an RI/CQI/PMI/LI) received from the UE with each other (e.g., via an X2 interface) or using the feedback channel information to effectively control interference. CoMP schemes may be divided into joint transmission (JT), coordinated scheduling (CS), coordinated beamforming (CB), dynamic point selection (DPS), and dynamic point blacking (DPB) according to their use mechanisms.

CoMP transmission was introduced to the LTE system, and partially introduced to NR Rel-15. For CoMP transmission, there are various schemes including a same layer joint transmission scheme in which a plurality of transmission and reception points (TRP) transmit the same signal or information, a point selection scheme in which a plurality of TRPs share information to be transmitted to a UE, and a specific TRP transmits the information to the UE at a specific time in consideration of radio channel quality or traffic load, and an independent layer joint transmission scheme in which a plurality of TRPs transmit different signals or information in spatial dimension multiplexing (SDM) from spatial layers. In a main point selection scheme called dynamic point selection (DPS), a TRP participating in transmission may be changed each time a PDSCH is transmitted. A term defined to indicate a TRP that transmits a PDSCH is quasi-co-location (QCL). The BS may indicate/configure to/or for the UE whether to assume that different antenna ports are identical in terms of a specific property (e.g., Doppler shift, Doppler spread, average delay, delay spread, or spatial reception (RX) parameter), by QCL. When TRP #1 transmits a PDSCH, the BS indicates a specific RS (e.g., CSI-RS resource #1) transmitted from TRP #1 and QCL between corresponding PDSCH DMRS antenna ports, and when TRP #2 transmits a PDSCH, the BS indicates a specific RS (e.g., CSI-RS resource #2) transmitted from TRP #2 and QCL between corresponding PDSCH DMRS antenna ports. To indicate instantaneous QCL information by DCI, a PDSCH quasi-co-location information (PQI) field is defined in LTE, and a transmission configuration information (TCI) field is defined in NR. The QCL indication/configuration method defined in the standards may generally be used for cooperative transmission between a plurality of TRPs, cooperative transmission between a plurality of panels (antenna groups) in the same TRP, and cooperative transmissions between a plurality of beams in the same TRP. This is because the use of different transmission panels or beams may lead to different Doppler delays or different reception beams (spatial Rx parameters) that signals transmitted by the panels or beams experience, despite the transmissions from the same TRP.

In NR Rel-16, standardization of a method of transmitting different layer groups to a UE by a plurality of TRPs/panels/beams, called independent layer joint transmission (ILJT) or non-coherent joint transmission (NCJT) is under discussion.

Multi-Transmission/Reception Point (Multi-TRP)-Related Operations

Multi-TRP (MTRP) transmission schemes in which M TRPs transmit data to a single UE may be divided into eMBB MTRP transmission for increasing a transmission rate significantly and URLLC MTRP transmission for increasing a reception success rate and reducing latency.

From the perspective of DCI transmission, MTRP transmission schemes may include i) a multiple DCI (M-DCI)-based MTRP transmission scheme in which each TRP transmits different DCI, and ii) a single DCI (S-DCI)-based MTRP transmission scheme in which a single TRP transmits DCI. For example, all scheduling information about data transmitted by multiple TRPs should be delivered by one piece of DCI in the S-DCI-based M-TRP transmission scheme. Accordingly, this scheme may be used in an ideal backhaul (BH) environment in which two TRPs may cooperate with each other dynamically.

Scheme 3/4 is being standardized in TDM-based URLLC. Specifically, scheme 4 refers to a scheme in which one TRP transmits a transport block (TB) in one slot. Scheme 4 achieves the effect that a data reception probability may be increased through the same TB received over multiple slots from multiple TRPs. In contrast, scheme 3 refers to a scheme in which one TRP transmits a TB over a few consecutive OFDM symbols (i.e., a symbol group). In scheme 3, multiple TRPs may be configured to transmit the same TB in different symbol groups within one slot.

Further, the UE may recognize PUSCHs (or PUCCHs) scheduled by DCI received in different CORESETs (or CORESETs of different CORESET groups) as PUSCHs (or PUCCHs) transmitted to different TRPs or PUSCHs (or PUCCHs) for different TRPs. Further, UL transmissions (e.g., PUSCHs/PUCCHs) directed to different TRPs may be performed in the same manner as UL transmissions (e.g., PUSCHs/PUCCHs) directed to different panels within the same TRP.

Further, MTRP-URLLC may refer to transmitting the same TB in different layers/times/frequencies from multiple TRPs. A UE configured with an MTRP-URLLC transmission scheme may be notified of TCI state(s) by DCI and assume that data received using a QCL RS of each TCI state is the same TB. MTRP-eMBB may refer to transmitting different TBs in different layers/times/frequencies from multiple TRPs. A UE configured with an MTRP-eMBB transmission scheme may be notified of TCI state(s) by DCI and assume that data received using a QCL RS of each TCI state is a different TB. In this regard, the UE may identify/determine whether a corresponding MTRP transmission is a URLLC transmission or an eMBB transmission by separately using an RNTI configured for MTRP-URLLC and an RNTI configured for MTRP-eMBB. That is, when DCI received by the UE has been CRC-masked by the RNTI for MTRP-URLLC, this may correspond to an URLLC transmission. When DCI received by the UE has been CRC-masked by the RNTI for MTRP-eMBB, this may correspond to an eMBB transmission.

The term CORESET group ID as described/mentioned in the present disclosure may mean an index/identification information (e.g., ID) identifying CORESETs of a TRP/panel. A CORESET group may be a group/union of CORESETs identified by an index/identification information (e.g., IDs)/a CORESET group ID for CORESETs of a TRP/panel. For example, a CORESET group ID may be specific index information defined by a CORESET configuration. For example, a CORESET group may be configured/indicated/defined by an index defined in the CORESET configuration of each CORESET. And/or a CORESET group ID may mean an index/identification information/indicator for distinguishing/identifying CORESETs configured for/associated with a TRP/panel. A CORESET group ID described/mentioned in the present disclosure may be replaced with a specific index/specific identification information/a specific indicator for distinguishing/identifying CORESETs configured for/associated with a TRP/panel. The CORESET group ID, that is, the specific index/specific identification information/specific indicator for distinguishing/identifying the CORESETs configured for/associated with the TRP/panel may be configured/indicated by higher-layer signaling (e.g., RRC signaling)/L2 signaling (e.g., a MAC control element (MAC-CE))/L1 signaling (e.g., DCI)). For example, it may be configured/indicated that a PDCCH from each TRP/panel is detected on a CORESET group basis, and/or it may be configured/indicated that UCI (e.g., CSI, HARQ-A/N, and SR) and/or UL physical channel resources (e.g., PUCCH/PRACH/SRS resources) for each TRP/panel are separately managed/controlled on a CORESET group basis, and/or an HARQ A/N (process/retransmission) for a PDSCH/PUSCH scheduled by each TRP/panel may be managed on a corresponding CORESET group basis.

For example, a higher-layer parameter, ControlResourceSet information element (IE) is used to configure a time/frequency CORESET. For example, the CORESET may be related to detection and reception of DCI. The ControlResourceSet IE may include the ID of a CORESET (e.g., controlResourceSetID)/the index of a CORESET pool of the CORESET (e.g., CORESETPoolIndex)/a time/frequency resource configuration for the CORESET/TCI information related to the CORESET. For example, the index of the CORESET pool (e.g., CORESETPoolIndex) may be set to 0 or 1. In the above description, a CORESET group may correspond to a CORESET pool, and a CORESET group ID may correspond to a CORESET pool index (e.g., CORESETPoolIndex).

HARQ Operation for Multiple TX/RX Points of Multiple Cells

When a single UE is configured with transmission and reception through multiple TRPs, one of the TRPs may use serving cell resources of the UE, and another TRP may use non-serving cell resources of the UE. In the present disclosure, the former TRP is referred to as a serving cell TRP, and the latter TRP is referred to as a cooperating cell TRP.

When a UL TB or DL TB is transmitted through an HARQ transmission in this MTRP environment, the UE may have different MAC entity and HARQ entity configurations according to a network configuration for a cooperating cell TRP and a serving cell TRP. Therefore, there may be a need for changing an HARQ process ID configuration and an HARQ A/N transmission scheme. Further, a MAC entity needs to be configured to transmit data of different priorities or quality of service (QoS) levels to different TRPs in consideration of different channel environments.

The UE configures one or more serving cells and one or more cooperating cells for multiple TRPs. The gNB configures a serving cell and a cooperating cell for the UE and interconnects the cells by hackhaul. The cooperating cell is a non-serving cell or a serving cell of another type.

In the present disclosure, UL resources for a specific cell/TRP may be interpreted as UL resources having specific DL RS(s) (DL RS set(s)) as beams (e.g., spatial filters and spatial relations) and/or pathloss reference RSs or as UL resources for a specific UE panel (ID).

Operation Between Transmitter and Receiver

A serving cell and a cooperating cell belong to different gNB-DUs or the same gNB-DU of the same gNB. A serving cell and a cooperating cell for a specific UE may or may not be connected by carrier aggregation (CA) or dual connectivity (DC). For the perspective of the UE, both the serving cell and the cooperating cell may be PCells, PSCells, or SCells, or only one of the serving cell and the cooperating cell may be a PCell, a PSCell, or an SCell. Alternatively, when the UE is performing handover, the serving cell may be a target cell, and the cooperating cell may be a source cell.

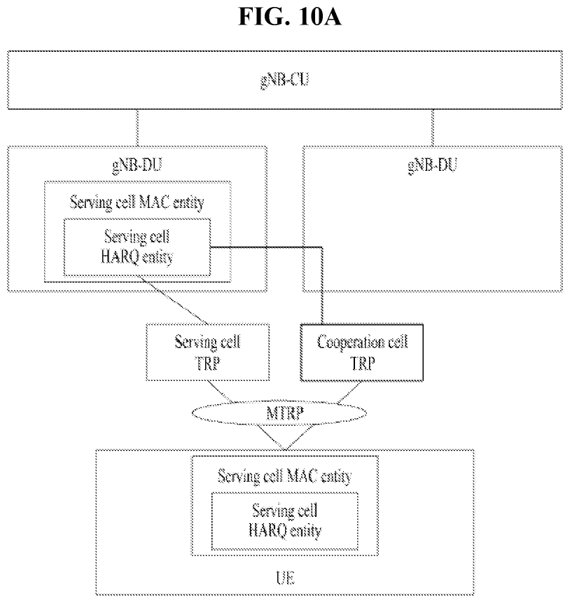

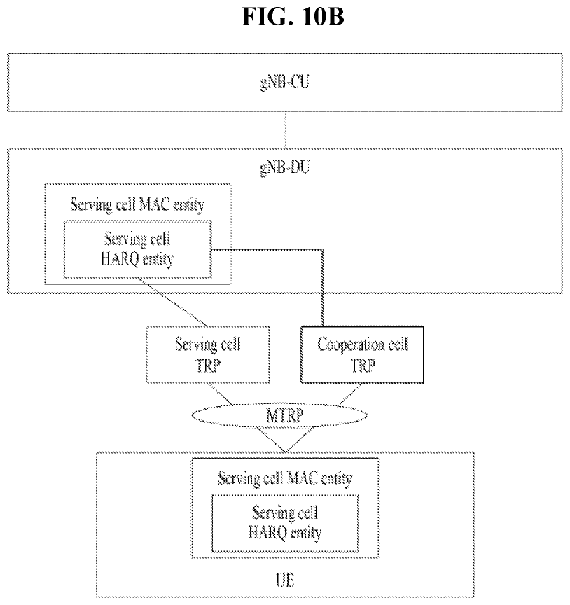

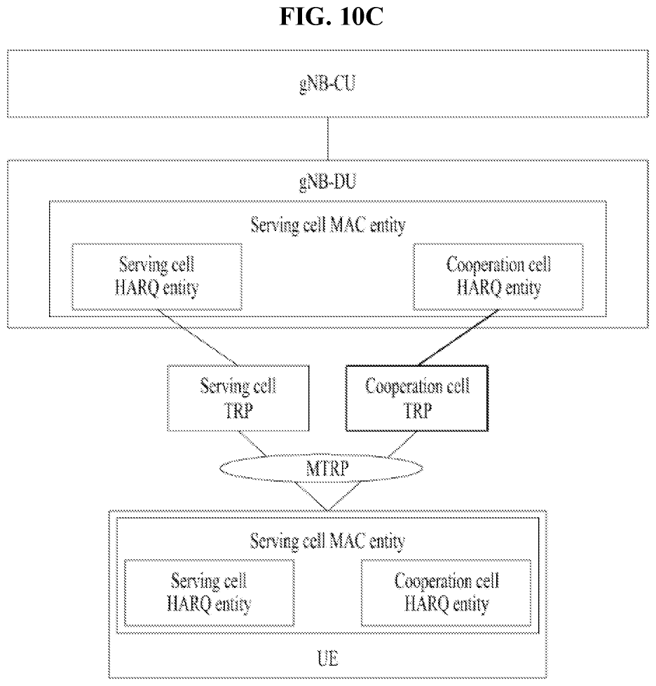

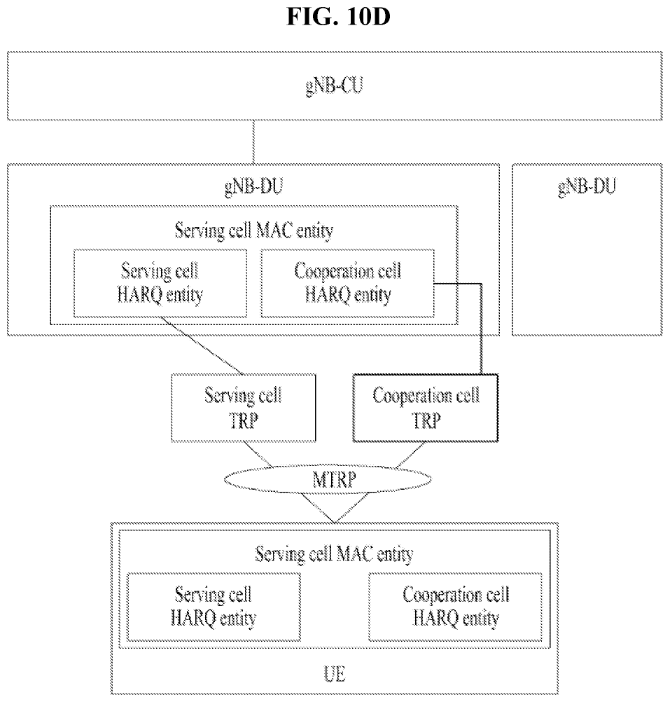

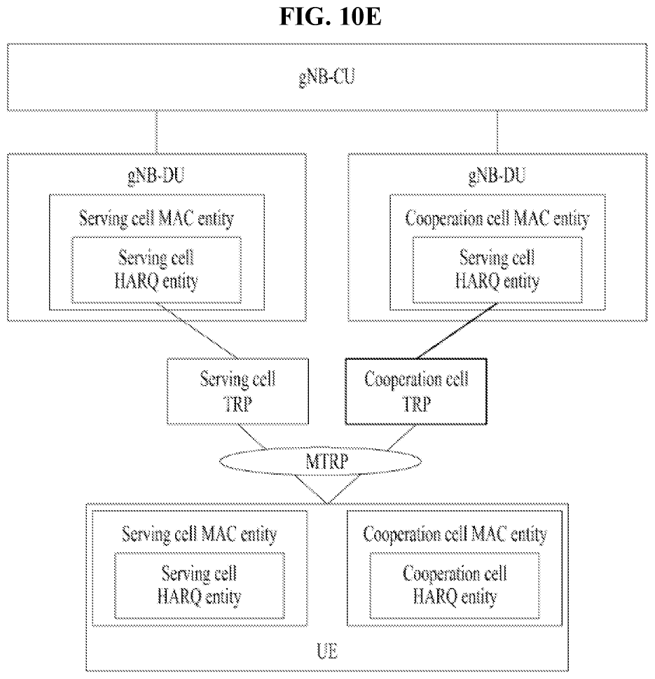

FIGS. 10A to 10E illustrate various embodiments of the configurations of MAC/HARQ entities in a UE and a gNB, for inter-cell MTRP applicable to the present disclosure.

Referring to FIGS. 10A to 10E, a gNB is divided into a gNB-centralized unit (gNB-CU) and a gNB-distributed unit (gNB-DU). A serving cell TRP, a cooperating cell TRP, MTRP, and a UE are illustrated. There may be one or more gNB-DUs, and each of a gNB and the UE includes a MAC entity and an HARQ entity.

Specifically, FIG. 10A illustrates the configuration of serving cell MAC/HARQ entities, when a serving cell and a cooperating cell have different gNB-DUs. FIG. 10B illustrates the configuration of serving cell MAC/HARQ entities, when a serving cell and a cooperating cell have the same gNB-DU. FIG. 10C illustrates the configuration of serving cell MAC/HARQ entities and cooperating cell HARQ entities, when a serving cell and a cooperating cell have the same gNB-DU. FIG. 10D illustrates the configuration of serving cell MAC/HARQ entities and cooperating cell HARQ entities, when a serving cell and a cooperating cell have different gNB-DUs. FIG. 10E illustrates the configuration of serving cell MAC/HARQ entities and cooperating cell MAC/HARQ entities, when a serving cell and a cooperating cell have different gNB-DUs.

Inter-Cell MTRP DL TB Transmission Method
In a DL transmission through MTRPs of a serving cell and a cooperation cell, one or more MAC entities located in one or more gNB-DUs configure transport blocks (TBs) for a serving cell TRP and a cooperating cell TRP. Preferably, the plurality of gNB-DUs are connected to the same gNB-CU, and different MAC entities for one UE may be located in the same or different gNB-DUs.
   In a first DL transmission method, each of a gNB and a UE is provided with a serving cell MAC entity, and the serving cell MAC entity of the gNB configures the same TB directed to the single UE and performs a reliable DL transmission of the TB.

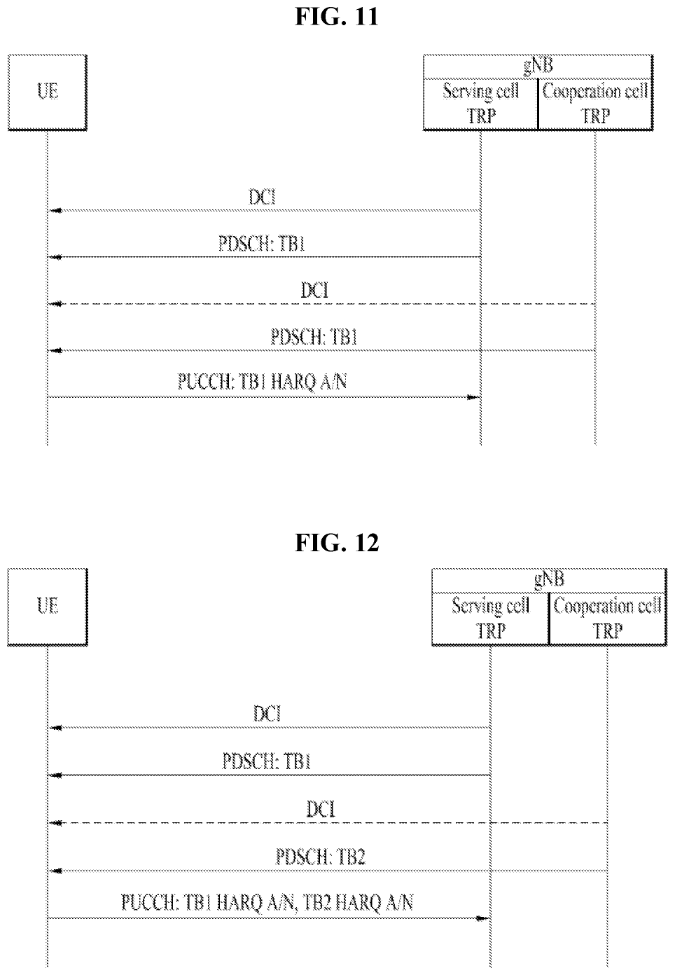

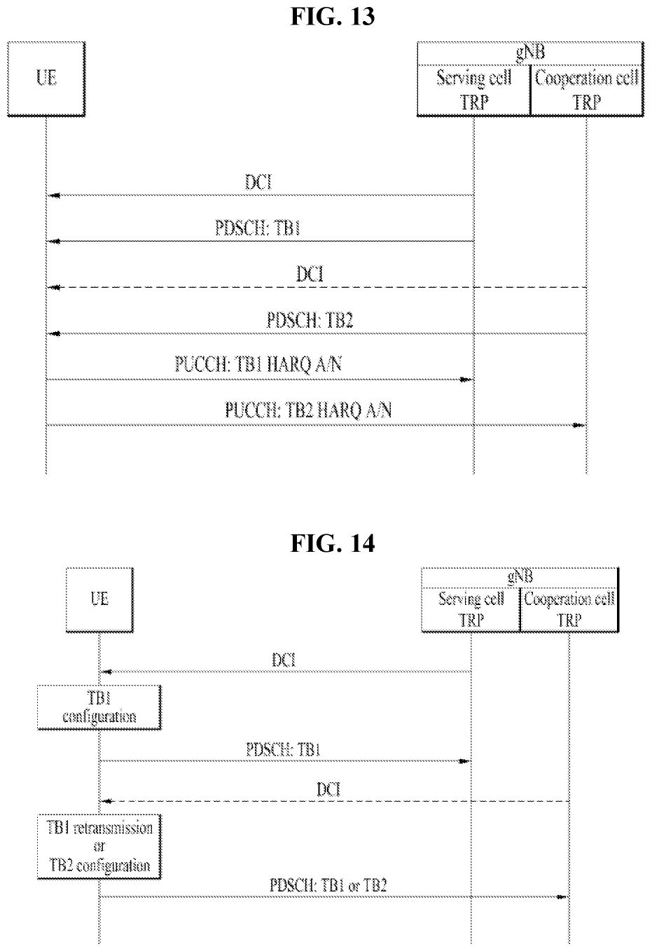

FIG. 11 illustrates an exemplary DL TB transmission method for inter-cell MTRP according to a MAC/HARQ entity configuration, applicable to the present disclosure.

In this method, DCI that schedules a serving cell PDSCH and DCI that schedules a cooperating cell PDSCH indicate the same HARQ process ID and the same or different TCI states. Accordingly, the serving cell MAC entity of the UE receives the serving cell PDSCH and the cooperating cell PDSCH in the same or different TCI states, and decodes one TB by combining the PDSCHs in one soft buffer corresponding to the indicated HARQ process ID. The UE transmits UCI including an HARQ A/N for the TB in serving cell TRP UL resources and forwards the UCI to the serving cell MAC entity, according to the decoding result.
In a second DL transmission method, each of the gNB and the UE is provided with a serving cell MAC entity, and the serving cell MAC entity of the gNB configures different TBs for the single UE, thereby increasing a transmission rate.

FIG. 12 illustrates another exemplary DL TB transmission method for inter-cell MTRP according to a MAC/HARQ entity configuration, applicable to the present disclosure.

In this method, DCI that schedules a serving cell PDSCH and DCI that schedules a cooperating cell PDSCH indicate different HARQ process IDs and the same or different TCI states. Accordingly, the serving cell MAC entity of the UE receives the serving cell PDSCH and the cooperating cell PDSCH in the same or different TCI states, and decodes different TBs by using soft buffers corresponding to the indicated HARQ process IDs. The UE transmits UCI including an HARQ A/N for each TB in serving cell TRP UL resources and forwards the UCI to the serving cell MAC entity, according to the decoding result.
a third DL transmission method, each of the gNB and the UE is provided with a serving cell HARQ entity and a cooperating cell HARQ entity, and the serving cell HARQ entity and the cooperating cell HARQ entity of the gNB configure different TBs for the single UE and transmit the TBs to the UE.

FIG. 12 illustrates another exemplary DL TB transmission method for inter-cell MTRP according to a MAC/HARQ entity configuration, applicable to the present disclosure.

Different HARQ entities are included in the same or different MAC entities. A gNB-CU maps different MAC entities to different TRPs and maps the different MAC entities and the different TRPs to the same or different logical channels or priorities, so that data having different QOS characteristics or priorities (logical channel priorities or high/low priority) are included in different TBs of the different MAC entities and transmitted through the TRPs of the different MAC entities.

Alternatively, the gNB-CU allows mapping of different HARQ entities to different TRPs and mapping of the different HARQ entities and the different TRPs to the same or different logical channels or priorities, so that data having different QOS characteristics or priorities (logical channel priorities or high/low priority) are included in different TBs of the different HARQ entities and transmitted through the TRPs of the different HARQ entities. In this method, different PDCCHs/PDSCHs are scheduled by different HARQ entities of the same or different MAC entities. DCI that schedules a serving PDSCH and DCI that schedules a cooperating cell PDSCH indicate different HARQ process IDs and the same or different TCI states.

Accordingly, the serving cell MAC entity of the UE receives the serving cell PDSCH and the cooperative cell PDSCH in the same or different TCI states, and decodes different TBs by using different soft buffers corresponding to the respective indicated HARQ process IDs. Alternatively, the serving cell HARQ entity and cooperating cell HARQ entity of the UE receive the serving cell PDSCH and the cooperating cell PDSCH, respectively, and decode different TBs by using the different soft buffers corresponding to the respective indicated HARQ process IDs. For this operation, the gNB allocates some of N HARQ process IDs mapped to the single UE to the TRP of the serving cell MAC/HARQ entity, and other HARQ process IDs to the TRP of the cooperating cell MAC/HARQ entity. Therefore, the UE may distinguish the different TRPs through HARQ process IDs indicated by DCI.

The UE transmits different UCIs including HARQ A/N's for the respective TBs in UL resources of the serving cell TRP and UL resources of the cooperating cell TRP according to the decoding result, respectively, and forwards the UCIs to the serving cell MAC/HARQ entity and the cooperating cell MAC/HARQ entity, respectively.

Alternatively, in this method, the DCI that schedules the serving cell PDSCH and the DCI that schedules the cooperating cell PDSCH for transmission of different TBs may indicate the same HARQ process ID. In this case, the gNB may overlappingly allocate the N HARQ process IDs mapped to the single UE to the serving cell MAC/HARQ entity and the cooperating cell MAC/HARQ entity. However, since the same HARQ process ID is mapped to the soft buffers of the different MAC/HARQ entities from the perspective of the UE, the UE may not identify a soft buffer in which a PDSCH scheduled by received DCI should be processed. Therefore, to indicate the soft buffers of the different MAC/HARQ entities, the DCI that schedules the serving cell PDSCH and the DCI that schedules the cooperating cell PDSCH indicate different TRP IDs, different cell indexes, or different HARQ entity IDs. To this end, the gNB may allocate different TRP IDs, different cell indexes, or different HARQ entities to the serving cell TRP and the cooperating cell TRP.

Inter-Cell MTRP UL TB Transmission Method

In a UL transmission through MTRPs of a serving cell and a cooperating cell, one or more MAC entities located in a UE configure TBs for a serving cell TRP and a cooperating cell TRP.

FIG. 14 illustrates an exemplary UL TB transmission method for inter-cell MTRP according to a MAC/HARQ entity configuration, applicable to the present disclosure.
In a first UL transmission method, each of a gNB and a UE is provided with a serving cell MAC entity, and the serving cell MAC entity of the UE configures the same TB directed to different cells and performs a reliable UL transmission of the TB. In this method, DCI that schedules a serving cell PUSCH and DCI that schedules a cooperating cell PUSCH may be the same or different, and the same or different DCIs indicate the same HARQ process ID and the same or different TCI states. Accordingly, the serving cell MAC entity of the UE transmits one TB stored in an HARQ process mapped to the same process ID on the serving cell PUSCH and the cooperating cell PUSCH in the same or different TCI states. The same or different serving cell gNB-DU and cooperating cell gNB-DU soft-combine the serving cell PUSCH transmission and the cooperating cell PUSCH transmission through the soft buffer of the same MAC entity, thereby decoding the one TB.
In a second UL transmission method, each of a gNB and a UE is provided with a serving cell MAC entity, and the serving cell MAC entity of the UE configures different TBs directed to different cells, thereby increasing a transmission rate. In this method, DCI that schedules a serving cell PUSCH and DCI that schedules a cooperating cell PUSCH may be the same or different, and the same or different DCIs indicate different HARQ process IDs and the same or different TCI states. For example, one DCI may indicate two HARQ process IDs or different DCIs may indicate different HARQ process IDs, so that the UE transmits two UL TBs to different TRBs. According to a gNB setting, the UE maps the same or different logical channels or priorities to different TRPs, so that data having different QoS characteristics or priorities (logical channel priorities) are included in different TBs for the different TRPs and transmitted to the TRPs of different MAC entities. Therefore, the serving cell MAC entity of the UE transmits different TBs stored in different HARQ processes mapped to different HARQ process IDs on the serving cell PUSCH and the cooperating cell PUSCH. For example, if the same or different DCIs indicate HARQ process ID=1 and HARQ process ID=2, the UE transmits TB1 corresponding to HARQ process ID=1 on the serving cell PUSCH and TB2 corresponding to HARQ process ID=2 on the cooperating cell PUSCH. The TRPs of the same or different serving cell gNB-DU and cooperating cell gNB-DU decode different TBs by soft-combining the serving cell PUSCH transmission and the cooperating cell PUSCH transmission in different soft buffers of the same MAC entity.
In a third UL transmission method, each of a gNB and a UE is provided with a serving cell HARQ entity and a cooperating cell HARQ entity, and the serving cell HARQ entity and cooperating cell HARQ entity of the UE configures different TBs directed to different cells, thereby increasing a transmission rate. The different HARQ entities are included in the same or different MAC entities of the UE. According to a gNB setting, the UE maps different MAC/HARQ entities of the UE to different TRPs and map different logical channels or priorities to the different MAC/HARQ entities and the different TRPs, so that data having different QoS characteristics or priorities (logical channel priorities or high/low priority) are included in different TBs of different HARQ entities of the same or different MAC entities and transmitted to different TRPs.

In this method, DCI that schedules a serving cell PUSCH transmission and DCI that schedules a cooperating cell PUSCH may be the same or different, and the same or different DCIs indicate different HARQ process IDs and the same or different TCI states. For example, one DCI may indicate two HARQ process IDs or different DCIs may indicate different HARQ process IDs, so that the UE may transmit two UL TBs. Accordingly, the serving cell MAC/HARQ entity of the UE transmits different TBs stored in different HARQ processes mapped to different HARQ process IDs on the serving cell PUSCH and the cooperating cell PUSCH. For example, when the same or different DCIs indicate HARQ process ID=1 and HARQ process ID=2, TB1 corresponding to ID=1 is transmitted on the serving cell PUSCH, and TB2 corresponding to ID=2 is transmitted on the cooperating cell PUSCH. In this case, the same or different serving cell gNB-DU and cooperating cell gNB-DU soft-combine the serving cell PUSCH transmission and the cooperating cell PUSCH transmission in soft buffers of different HARQ entities to decode different TBs.

Alternatively, in this method, the same or different DCIs may indicate the same HARQ process IDs and the same or different TCI states. In this case, the gNB may overlappingly allocate N HARQ process IDs mapped to the single UE to the serving cell MAC/HARQ entity and the cooperating cell MAC/HARQ entity. To indicate the HARQ buffers of different MAC/HARQ entities, the DCI scheduling the serving cell PUSCH and the DCI scheduling the cooperating cell PUSCH may indicate different TRP IDs, different cell indexes, or different HARQ entity IDs. To this end, the gNB may allocate different TRP IDs to a serving cell TRP and a cooperating cell TRP, allocate different cell indexes to the serving cell and the cooperative cell, or allocate different HARQ entities to the serving cell and the cooperating cell. For example, when all of different DCIs indicate HARQ process ID=1 and indicate different TRP IDs, cell Indexes, or HARQ entity IDs, TB1 is transmitted on the serving cell PUSCH, and second TB2 is transmitted as the cooperating cell PUSCH. In this case, TB1 may include data having a higher priority than TB2 or a more stringent delay requirement than TB2. On the other hand, the same or different serving cell gNB-DU and cooperating cell gNB-DU soft-combine the serving cell PUSCH transmission and the cooperating cell PUSCH transmission in soft buffers of different HARQ entities to decode different TBs.

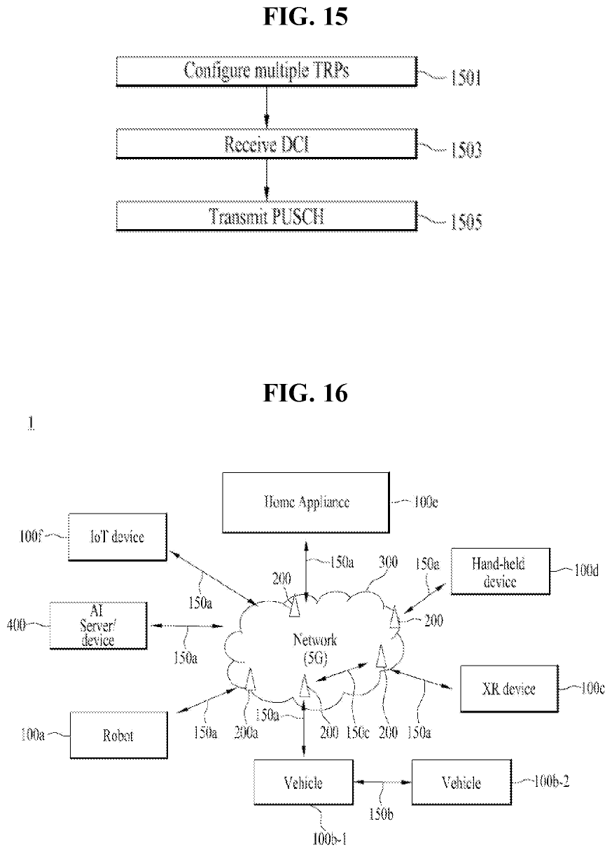

FIG. 15 illustrates a method of receiving a signal by a UE according to an embodiment of the present disclosure.

The UE configures a plurality of TRPs (1501). For example, the UE configures a first TRP using resources of a first cell and a second TRP using resources of a second cell. The first cell may be a cooperating cell, and the second cell may be a serving cell.

The UE receives DCI from a gNB (1503). For example, the UE may receive first DCI scheduling a first PUSCH and receive second DCI scheduling a second PUSCH. The UE may receive one DCI that schedules the first PUSCH and the second PUSCH.

The UE transmits a PUSCH to multiple TRPs based on the DCIs (1505). For example, the UE may transmit the first PUSCH to a first TRP and transmit a second PUSCH to a second TRP.

Alternatively, one DCI may indicate two HARQ process IDs or different DCIs may indicate different HARQ process IDs, so that the UE may transmit two TBs.

Effects of the Present Disclosure

The present disclosure proposes the configuration of MAC entities and HARQ entities of a UE and a BS according to a network configuration for a cooperating cell TRP and a serving cell TRP, and proposes a related HARQ ID setting and HARQ A/N transmission method to enable a UL or DL TB transmission through a HARQ transmission in an MTRP environment. Further, a MAC entity is configured such that the UE may transmit data having different priorities or QoSs to different TRPs according to a BS setting. Therefore, different TBs may be configured according to different channel environments.

FIG. 16 illustrates a communication system 1 applied to the present disclosure.

Referring to FIG. 16, a communication system 1 applied to the present disclosure includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an eXtended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous driving vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

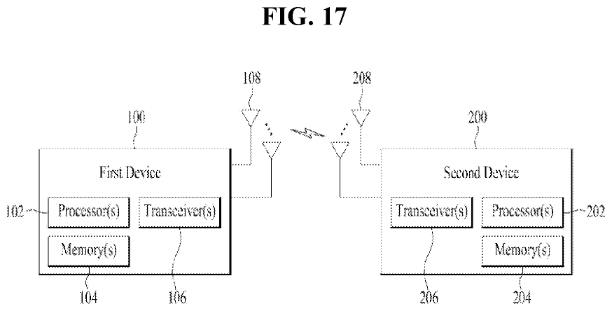

FIG. 17 illustrates wireless devices applicable to the present disclosure.

Referring to FIG. 17, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 16.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

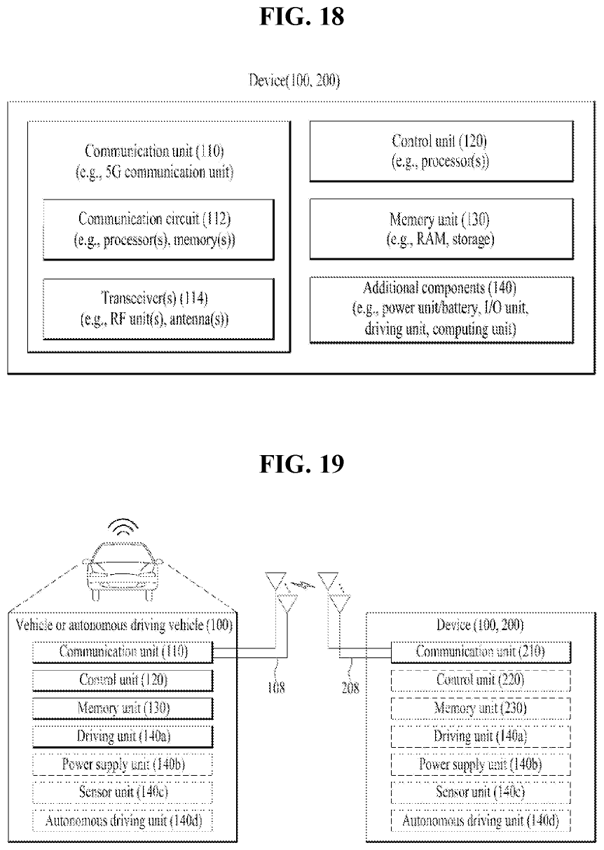

FIG. 18 illustrates another example of a wireless device applied to the present disclosure. The wireless device may be implemented in various forms according to a use-case/service (refer to FIG. 18).

Referring to FIG. 18, wireless devices 100 and 200 may correspond to the wireless devices 100 and 200 of FIG. 17 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 17. For example, the transceiver(s) 114 may include the one or more transceivers 106 and 206 and/or the one or more antennas 108 and 208 of FIG. 17. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 16), the vehicles (100b-1 and 100b-2 of FIG. 16), the XR device (100c of FIG. 16), the hand-held device (100d of FIG. 16), the home appliance (100e of FIG. 16), the IoT device (100f of FIG. 16), a digital broadcast terminal, a hologram device, a public safety device, an MTC device, a medicine device, a fintech device (or a finance device), a security device, a climate/environment device, the AI server/device (400 of FIG. 16), the BSs (200 of FIG. 16), a network node, etc. The wireless device may be used in a mobile or fixed place according to a use-example/service.

In FIG. 18, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

FIG. 19 illustrates a vehicle or an autonomous driving vehicle applied to the present disclosure. The vehicle or autonomous driving vehicle may be implemented by a mobile robot, a car, a train, a manned/unmanned Aerial Vehicle (AV), a ship, etc.

Referring to FIG. 19, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 18, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an Electronic Control Unit (ECU). The driving unit 140a may cause the vehicle or the autonomous driving vehicle 100 to drive on a road. The driving unit 140a may include an engine, a motor, a powertrain, a wheel, a brake, a steering device, etc. The power supply unit 140b may supply power to the vehicle or the autonomous driving vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the obtained data. The control unit 120 may control the driving unit 140a such that the vehicle or the autonomous driving vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly obtained data/information. The communication unit 110 may transfer information about a vehicle position, the autonomous driving path, and/or the driving plan to the external server. The external server may predict traffic information data using AI technology, etc., based on the information collected from vehicles or autonomous driving vehicles and provide the predicted traffic information data to the vehicles or the autonomous driving vehicles.

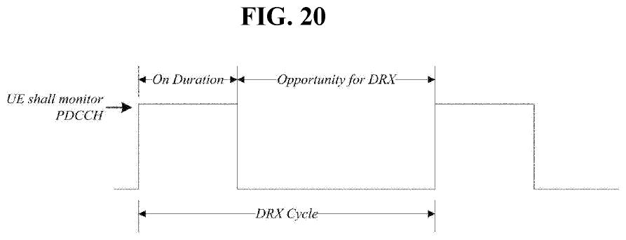

FIG. 20 is a diagram illustrating a DRX operation of a UE according to an embodiment of the present disclosure.

The UE may perform a DRX operation in the afore-described/proposed procedures and/or methods. A UE configured with DRX may reduce power consumption by receiving a DL signal discontinuously. DRX may be performed in an RRC_IDLE state, an RRC_INACTIVE state, and an RRC_CONNECTED state. The UE performs DRX to receive a paging signal discontinuously in the RRC_IDLE state and the RRC_INACTIVE state. DRX in the RRC_CONNECTED state (RRC_CONNECTED DRX) will be described below.

Referring to FIG. 20, a DRX cycle includes an On Duration and an Opportunity for DRX. The DRX cycle defines a time interval between periodic repetitions of the On Duration. The On Duration is a time period during which the UE monitors a PDCCH. When the UE is configured with DRX, the UE performs PDCCH monitoring during the On Duration. When the UE successfully detects a PDCCH during the PDCCH monitoring, the UE starts an inactivity timer and is kept awake. On the contrary, when the UE fails in detecting any PDCCH during the PDCCH monitoring, the UE transitions to a sleep state after the On Duration. Accordingly, when DRX is configured, PDCCH monitoring/reception may be performed discontinuously in the time domain in the afore-described/proposed procedures and/or methods. For example, when DRX is configured, PDCCH reception occasions (e.g., slots with PDCCH SSs) may be configured discontinuously according to a DRX configuration in the present disclosure. On the contrary, when DRX is not configured, PDCCH monitoring/reception may be performed continuously in the time domain. For example, when DRX is not configured, PDCCH reception occasions (e.g., slots with PDCCH SSs) may be configured continuously in the present disclosure. Irrespective of whether DRX is configured, PDCCH monitoring may be restricted during a time period configured as a measurement gap.

Table 7 describes a DRX operation of a UE (in the RRC_CONNECTED state). Referring to Table 7, DRX configuration information is received by higher-layer signaling (e.g., RRC signaling), and DRX ON/OFF is controlled by a DRX command from the MAC layer. Once DRX is configured, the UE may perform PDCCH monitoring discontinuously in performing the afore-described/proposed procedures and/or methods, as illustrated in FIG. 5.

TABLE 7

| | Type of signals | UE procedure |
|---|---|---|
| 1^{st} step | RRC signalling(MAC- | Receive DRX configuration |
| | CellGroupConfig) | information |
| 2^{nd} Step | MAC CE((Long) DRX | Receive DRX command |
| | command MAC CE) | |
| 3^{rd} Step | — | Monitor a PDCCH during an |
| | | on-duration of a DRX cycle |

MAC-CellGroupConfig includes configuration information required to configure MAC parameters for a cell group. MAC-CellGroupConfig may also include DRX configuration information. For example, MAC-CellGroupConfig may include the following information in defining DRX.
Value of drx-OnDurationTimer: defines the duration of the starting period of the DRX cycle.
Value of drx-InactivityTimer: defines the duration of a time period during which the UE is awake after a PDCCH occasion in which a PDCCH indicating initial UL or DL data has been detected
Value of drx-HARQ-RTT-TimerDL: defines the duration of a maximum time period until a DL retransmission is received after reception of a DL initial transmission.
Value of drx-HARQ-RTT-TimerDL: defines the duration of a maximum time period until a grant for a UL retransmission is received after reception of a grant for a UL initial transmission.
drx-LongCycleStartOffset: defines the duration and starting time of a DRX cycle.
drx-ShortCycle (optional): defines the duration of a short DRX cycle.

When any of drx-OnDurationTimer, drx-InactivityTimer, drx-HARQ-RTT-TimerDL, and drx-HARQ-RTT-TimerDL is running, the UE performs PDCCH monitoring in each PDCCH occasion, staying in the awake state.

What is claimed is:

1. A method of receiving a signal by a user equipment (UE) in a wireless communication system, the method comprising:
configuring a first transmission and reception point (TRP) using resources of a first cell;
configuring a second TRP using resources of a second cell;
receiving first downlink control information (DCI) scheduling a first physical uplink shared channel (PUSCH);
receiving second DCI scheduling a second PUSCH;
transmitting the first PUSCH to the first TRP; and
transmitting the second PUSCH to the second TRP,
wherein the first DCI and the second DCI include information about a hybrid automatic repeat request (HARQ) process identifier (ID) and a transmission configuration indicator (TCI) state, and
wherein the first cell is a cooperating cell, and the second cell is a serving cell.

2. The method according to claim 1, wherein when the first DCI and the second DCI indicate the same HARQ process ID, the first PUSCH and the second PUSCH include the same transport block (TB).

3. The method according to claim 2, wherein the UE configures a medium access control (MAC) entity of the second cell, and
wherein the same TB is configured by the MAC entity of the second cell.

4. The method according to claim 1, wherein when the first DCI and the second DCI indicate different HARQ process IDs, the first PUSCH and the second PUSCH include different TBs.

5. The method according to claim 4, wherein the UE configures a MAC entity of the second cell, and
wherein the different TBs are configured by the MAC entity of the second cell.

6. The method according to claim 4, wherein the UE configures an HARQ entity of the first cell and an HARQ entity of the second cell, separately, and
wherein the different TBs are configured respectively by the HARQ entity of the first cell and the HARQ entity of the second cell.

7. The method according to claim 4, wherein the same or different logical channels or priorities are mapped to the first TRP and the second TRP.

8. The method according to claim 7, wherein data having different qualities of service (QoSs) or priorities are included respectively in the different TBs configured by the HARQ entity of the first cell and the HARQ entity of the second cell.

9. A non-transitory computer-readable medium recording a program code for performing the method according to claim 1.

10. A user equipment (UE) for receiving a signal in a wireless communication system, the UE comprising:
a transceiver; and
at least one processor coupled to the transceiver,
wherein the at least one processor is configured to:
configure a first transmission and reception point (TRP) using resources of a first cell and a second TRP using resources of a second cell;
receive first downlink control information (DCI) scheduling a first physical uplink shared channel (PUSCH);
receive second DCI scheduling a second PUSCH;
transmit the first PUSCH to the first TRP; and
transmit the second PUSCH to the second TRP,
wherein the first DCI and the second DCI include information about a hybrid automatic repeat request (HARQ) process identifier (ID) and a transmission configuration indicator (TCI) state, and
wherein the first cell is a cooperating cell, and the second cell is a serving cell.

11. The UE according to claim 10, wherein when the first DCI and the second DCI indicate the same HARQ process ID, the first PUSCH and the second PUSCH include the same transport block (TB).

12. The UE according to claim 11, wherein the processor is configured to configure a medium access control (MAC) entity of the second cell, and
wherein the same TB is configured by the MAC entity of the second cell.

13. The UE according to claim 10, wherein when the first DCI and the second DCI indicate different HARQ process IDs, the first PUSCH and the second PUSCH include different TBs.

14. The UE according to claim 13, wherein the processor is configured to configure a MAC entity of the second cell, and
wherein the different TBs are configured by the MAC entity of the second cell.

15. The UE according to claim 13, wherein the processor is configured to configure an HARQ entity of the first cell and an HARQ entity of the second cell, separately, and
wherein the different TBs are configured respectively by the HARQ entity of the first cell and the HARQ entity of the second cell.
